(19) United States
(12) Patent Application Publication
(10) Pub. No.: US 2006/0066006 A1
(43) Pub. Date: Mar. 30, 2006

(54) Fabrication of 3d photopolymeric devices

(76) Inventors: K. Tommy Haraldsson, Boulder, CO (US); J Brian Hutchison, Boulder, CO (US); Christopher Bowman, Boulder, CO (US); Kristi Anseth, Boulder, CO (US)

Correspondence Address: GREENLEE WINNER AND SULLIVAN P C, 4875 PEARL EAST CIRCLE, SUITE 200, BOULDER, CO, 80301, US

(21) Appl. No.: 10/521,635

(22) PCT Filed: Jul. 21, 2003
(86) PCT No.: PCT/US03/22895

§ 371 Date: Oct. 26, 2005

Related U.S. Application Data
(60) Provisional application No. 60/397,215, filed on Jul. 19, 2002.

(51) Int. Cl. B29C 35/08; B29C 41/02; B29C 41/22

(52) U.S. Cl. 264/255; 264/494; 264/496; 264/317; 425/174.4

(57) ABSTRACT

A process and apparatus for making polymeric layers. A layer of liquid (20) including a photopolymerizable precursor is formed between a substrate (17) and a photomask (12). A reaction chamber is formed by a base (15), side walls (16) and photomask (12) polymerizes one or more regions of the liquid layer (20) to form a polymeric layer.

### CROSS-REFERENCE TO RELATED APPLICATIONS

This application claims the benefit of U.S. Provisional Application No. 60/397,215, filed Jul. 19, 2002, which is incorporated by reference in its entirety to the extent not inconsistent with the disclosure herewith.

### BACKGROUND

The present invention is in the field of photolithographic fabrication of polymeric devices, in particular methods and apparatus for fabricating polymeric layers and devices, especially microdevices.

State of the art processes for fabrication of Micro Electro Mechanical Systems (MEMS) utilize photolithographic processes and methods derived from the semiconductor industry. More recently developed methods include “soft lithography” (Whitesides et al, Angew chem. Int ed, 37; 550-575, (1998)) and microfluidic tectonics (U.S. Pat. No. 6,488,872, Beebe et al., Nature; 404:588-59 (2000)). Reviews and other discussions of polymer microdevice fabrication include Madou, M. J. Fundamentals of Microfabrication: The Science of Miniaturization; 2nd ed.; CRC Press: Boca Raton, 1997; Becker, H., and Locascio, L. E. “Polymer microfluidic devices.” Talanta, 56(2):267-287, 2002; Quake, S. R., and Scherer, A. “From micro- to nanofabrication with soft materials.” Science, 290(5496):1536-1540, 2000; and Whitesides, G. M., and Stroock, A. D. “Flexible methods for microfluidics.” Physics Today, 54(6):42-48, 2001.

Microstereolithography is a technique that incorporates a focused light source with photoactive monomers (Chatwin, C., Farsari, M., Huang, S. P., Heywood, M., Birch, P., Young, R., and Richardson, J. “UV microstereolithography system that uses spatial light modulator technology.” Applied Optics, 37(32):7514-7522, 1998; Cumpston, B. H., Ananthavel, S. P., Barlow, S., Dyer, D. L., Ehrlich, J. E., Erskine, L. L., Heikal, A. A., Kuebler, S. M., Lee, I. Y. S., McCord-Maughon, D., Qin, J. Q., Rockel, H., Rumi, M., Wu, X. L., Marder, S. R., and Perry, J. W. “Two-photon polymerization initiators for three-dimensional optical data storage and microfabrication.” Nature, 398(6722):51-54, 1999; Neckers, D. C., Hassoon, S., and Klimtchuk, E. “Photochemistry and photophysics of hydroxyfluorones and xanthenes.” Journal of Photochemistry and Photobiology A—Chemistry, 95(1):33-39, 1996). Curing sequential cross-sectional layers on top of each other results in three-dimensional structures. Often, this process does not facilitate highly parallel fabrication, and a relatively long time is required for high-resolution microstructure fabrication.

Another strategy for polymeric device fabrication on the microscale is hot embossing (Madou, M. J. Fundamentals of Microfabrication: The Science of Miniaturization; 2nd ed.; CRC Press: Boca Raton, 1997; Becker, H., and Heim, U. “Hot embossing as a method for the fabrication of polymer high aspect ratio structures.” Sensors and Actuators A—Physical, 83(1-3):130-135, 2000). This requires a metal or semiconductor stamp or mold, known as the embossing tool, which is heated above the glass transition temperature of a polymer substrate. Pressure is applied to the tool and the negative topography is transferred to the softened polymer. The system is cooled, the stamp is removed, and the polymer retains the relief structure of the embossing tool. This leads to highly resolved designs but requires facilities to micromachine the original tool. Furthermore, the design is limited to one layer or multiple layers must be laminated together with precise alignment.

The most common approach to fabricating polymeric microdevices, particularly microfluidic devices, is soft lithography. This encompasses a variety of specific techniques. In general, these processes do not require photolithography; an elastomeric master (often poly(dimethylsiloxane), PDMS) is made from any relief structure and used to pattern features onto a number of different surfaces, including polymers (Anderson, J. R., Chiu, D. T., Jackman, R. J., Cherniavskaya, O., McDonald, J. C., Wu, H. K., Whitesides, S. H., and Whitesides, G. M. “Fabrication of topologically complex three-dimensional microfluidic systems in PDMS by rapid prototyping.” Analytical Chemistry, 72(14):3158-3164, 2000; Duffy, D. C., McDonald, J. C., Schueller, O. J. A., and Whitesides, G. M. “Rapid prototyping of microfluidic systems in poly(dimethylsiloxane).” Analytical Chemistry, 70(23):4974-4984, 1998; Love, J. C., Anderson, J. R., and Whitesides, G. M. “Fabrication of three-dimensional microfluidic systems by soft lithography.” MRS Bulletin, 26(7):523-528, 2001; Wu, H. K., Odom, T. W., Chiu, D. T., and Whitesides, G. M. “Fabrication of complex three-dimensional microchannel systems in PDMS.” Journal of the American Chemical Society, 125(2):554-559, 2003; xia, Y. N., and Whitesides, G. M. “Soft lithography.” Annual Review of Materials Science, 28:153-184, 1998). The overall method has been classified into a number of specific techniques (e.g., microcontact printing (μCP), replica molding (REM), microtransfer molding (μTM), micromolding in capillaries (MIMIC), and solvent-assisted micromolding (SAMIM) (Xia, Y. N., and Whitesides, G. M. “Soft lithography.” Annual Review of Materials Science, 28:153-184, 1998)). However, all of the individual techniques included within the method of soft lithography require the fabrication of a PDMS master from a relief structure, which is often a surface micromachined silicon wafer.

In addition to microcontact printing, which is a very common application of soft lithography, micromolding techniques for rapid prototyping of high aspect ratio polymer microdevices have been introduced (Anderson, J. R., Chiu, D. T., Jackman, R. J., Cherniavskaya, O., McDonald, J. C., Wu, H. K., Whitesides, S. H., and whitesides, G. M. “Fabrication of topologically complex three-dimensional microfluidic systems in PDMS by rapid prototyping.” Analytical Chemistry, 72(14):3158-3164, 2000; Duffy, D. C., McDonald, J. C., Schueller, O. J. A., and Whitesides, G. M. “Rapid prototyping of microfluidic systems in poly(dimethylsiloxane).” Analytical Chemistry, 70(23):4974-4984, 1998; Wu, H. K., Odom, T. W., Chiu, D. T., and Whitesides, G. M. “Fabrication of complex three-dimensional microchannel systems in PDMS.” Journal of the American Chemical Society, 125(2):554-559, 2003; Hanemann, T., Ruprecht, R., and Hausselt, J. H. “Micromolding and photopolymerization.” Advanced Materials, 9(11):927-929, 1997). In brief, the techniques entail filling recessed regions of a PDMS mold with a monomer or polymer solution and curing or evaporating the solvent to solidify the polymer. In these methods, negative transfer of the mold is obtained. Finally, the master is removed and can be reused in the same manner. Like other soft lithography techniques, each layer requires a separate master. Furthermore, in many cases, adjacent layers are physically adhered. Alternatively, in the case of multilayer PDMS structures, adjacent layers covalently bind upon contact, which suggests that precise alignment prior to contact is critical.

Step-and-flash imprint lithography uses photopolymerization through a rigid transparent imprint template to define pattern topography on a substrate (Willson Research Group website [online], [retrieved on Jul. 17, 2003] Retrieved from the Internet: <http://willson.com.utexas.edu/Research/Sub_Files/SFIL/Process/index.htm>).

Direct photolithography of photopolymers is the most robust method for fabrication of polymeric microdevices. The most common application of this technology is in the use of photoresists for any photolithography application. Most photoresists contain three components: a solvent for spreading the resist on a substrate, an organic polymer that resists etchants, and a photosensitizer that causes reaction or solubility (depending on chemistry and processing steps) of the polymer once exposed to UV radiation (Madou, M. J. Fundamentals of Microfabrication: The Science of Miniaturization; 2nd ed.; CRC Press: Boca Raton, 1997). Patterned resists can be used as simple devices or they can be used as a negative mold for another polymer (e.g., the relief structures for soft lithography techniques). Once the desired polymer is cured in the resist mold, then the resist can be removed via standard methods.

Direct application of photopolymerizable monomers for microdevice fabrication is an avenue that has been largely unexplored. For example, a solution containing monomer and photoinitiator can be polymerized directly by exposure to UV or visible light (depending on the initiator absorbance). The combination of photopolymerization technology and highly controlled light exposure via masking yields a straightforward method for parallel production of geometrically- and functionally complex microscale devices.

Beebe et al. (U.S. Pat. No. 6,488,872) relate to microfabricated devices manufactured from a substrate having microscale fluid channels, where Beebe et al.'s microscale fluid channels have a cross-section diameter of about 1 micron to about 1 millimeter. Polymer components are created inside a cartridge via direct photopatterning of a liquid phase polymerizable mixture. Beebe et al. state that structures that are close together (i.e. approximately 300 microns) typically are not fabricated simultaneously because of a partial polymerization occurring between the objects. Beebe and coworkers (Khoury, C., Mensing, G. A., and Beebe, D. J. “Ultra rapid prototyping of microfluidic systems using liquid phase photopolymerization.” Lab On a Chip, 2(1):50-55, 2002; Beebe, D. J., Moore, J. S., Yu, Q., Liu, R. H., Kraft, M. L., Jo, B. H., and Devadoss, C. “Microfluidic tectonics: A comprehensive construction platform for microfluidic systems.” Proceedings of the National Academy of Sciences of the United States of America, 97(25):13488-13493, 2000; Beebe, D. J., Moore, J. S., Bauer, J. M., Yu, Q., Liu, R. H., Devadoss, C., and Jo, B. H. “Functional hydrogel structures for autonomous flow control inside microfluidic channels.” Nature, 404(6778):588-590, 2000) fabricated channels, valves, and pumps for microfluidic systems using photopolymerization of multifunctional monomers. In particular, Beebe et al. incorporated hydrogel networks (i.e., loosely crosslinked hydrophilic polymers that swell in the presence of water) into hydrophobic polymer channels for various valve and sensor designs. Although swelling kinetics in macroscopic networks are much too slow for valve operations, the significant increase in surface area to volume ratio at the microscale facilitates relatively fast actuation of hydrogel valves—on the order of seconds (De, S. K., Aluru, N. R., Johnson, B., Crone, W. C., Beebe, D. J., and Moore, J. “Equilibrium swelling and kinetics of pH-responsive hydrogels: Models, experiments, and simulations.” Journal of Microelectromechanical Systems, 11(5):544-555, 2002). Other groups have used direct photopolymerization of monoliths within channels to form microfluidic valves (Hasselbrink, E. F., Shepodd, T. J., and Rehm, J. E. “High-pressure microfluidic control in lab-on-a-chip devices using mobile polymer monoliths.” Analytical Chemistry, 74(19):4913-4918, 2002; Kirby, B. J., Shepodd, T. J., and Hasselbrink, E. F. “Voltage-addressable on/off microvalves for high-pressure microchip separations.” Journal of Chromatography A, 979(1-2):147-154, 2002), and separations or combinatorial chemistry platforms (Peters, E. C., Svec, F., Frechet, J. M. J., Viklund, C., and Irgum, K. “Control of porous properties and surface chemistry in “molded” porous polymer monoliths prepared by polymerization in the presence of TEMPO.” Macromolecules, 32(19):6377-6379, 1999; Tripp, J. A., Svec, F., and Frechet, J. M. J. “Grafted macroporous polymer monolithic disks: A new format of scavengers for solution-phase combinatorial chemistry.” Journal of Combinatorial Chemistry, 3(2):216-223, 2001).

Furthermore, a multivinyl monomeric precursor material containing silicon, carbon, and nitrogen (i.e., Ceraset) has been implemented for microfabrication of high temperature ceramic MEMS devices (Yang, H., Deschatelets, P., Brittain, S. T., and Whitesides, G. M. “Fabrication of high performance ceramic microstructures from a polymeric precursor using soft lithography.” Advanced Materials, 13(1):54-58, 2001; Liew, L. A., Zhang, W. G., Bright, V. M., An, L. N., Dunn, M. L., and Raj, R. “Fabrication of SiCN ceramic MEMS using injectable polymer-precursor technique.” Sensors and Actuators A—Physical, 89(1-2):64-70, 2001; Liew, L. A., Liu, Y. P., Luo, R. L., Cross, T., An, L. N., Bright, V. M., Dunn, M. L., Daily, J. W., and Raj, R. “Fabrication of SiCN MEMS by photopolymerization of pre-ceramic polymer?” Sensors and Actuators A—Physical, 95(2-3):120-134, 2002; Liew, L. A., Saravanan, R. A., Bright, V. M., Dunn, M. L., Daily, J. W., and Raj, R. “Processing and characterization of silicon carbon-nitride ceramics: application of electrical properties towards MEMS thermal actuators.” Sensors and Actuators A—Physical, 103(1-2):171-181, 2003; Seok, W. K., and Sneddon, L. G. “Synthesis and ceramic conversion reactions of decaborane-CERASET polymers: New processable precursors to SiC/Si3N4/BN ceramics.” Bulletin of the Korean Chemical Society, 19(12):1398-1402, 1998). After photopolymerization by direct photolithographic UV exposure, the microfabricated polymer was pyrolyzed to create an amorphous Si—C—N ceramic that has utility for high temperature applications.

Madou, Fundamentals of Microfabrication: The Science of Miniaturization, CRC Press, Boca Raton, p 337, ((1997)) discusses casting of a “thick” PMMA resist layer on a metal substrate using thermal polymerization. Polymerization at room temperature takes place with benzoyl peroxide catalyst as the hardener and dimethylaniline as the starter or initiator.

Many specialized, integrated devices have been made using the aforementioned methods, but still numerous restrictions in design and fabrication of MEMS exist. Typically, for IC derived processes each new device requires specialized equipment, materials and processes to function optimally keeping device costs prohibitively high. Soft lithography and microfluidic tectonics have restrictions in material properties as well as available geometries, limiting applications and functions of the finished devices. This has held back market penetration except for a few high volume applications, most notably in the actuator field, e.g. accelerometers used in automotive air bag applications.

While MEMS researchers have successfully applied semiconductor processes in constructing specialized sensors and actuators from various silicon morphologies, integration with fluidic systems and external equipment has been slow. These difficulties arise from the different size requirements that a fully integrated microsystem optimally encompass, preferably electrical components are on the micron scale, fluidic systems on the sub millimeter scale and external connections ranging from sub millimeter to millimeter scale. This usually means that the components are fabricated separately, and assembled onto specialized fluidics structures, forming the finished device.

Typically, current processes are limited to materials such as silicon, glass, silicon rubber, and thermoplastic materials in at least one plane of the device, e.g. one channel surface. This limits the ability to withstand external factors such as impact forces and solvents. Furthermore, three dimensional devices fabricated from, or containing, these materials require micromachining and specialized bonding techniques, limiting feature size and ease of manufacture.

In an embodiment, the present invention is directed to methods and apparatus for manufacturing polymeric microdevices that overcome the limitations of currently known processes.

### SUMMARY OF THE INVENTION

Embodiments of the methods of the present invention allow for photolithographic fabrication of a polymeric layer. Embodiments of the methods of the present invention also allow for fabrication of monolithic, seamless, 3D devices with arbitrary feature heights. In the 3D devices of the invention, the material properties can be readily tailored within each layer that forms the device without the need to assemble and bond individual components or layers to form the device. Furthermore, the methods of the invention allow for non-planar geometries as well as ease of incorporation of materials traditionally not made using photolithography, e.g. filters.

Embodiments of the methods of the invention provide a photolithographic method for making a polymeric layer on a substrate. The polymeric layer can be patterned or not. In the methods of the invention, a patterned polymeric layer is formed by selective polymerization of a liquid comprising a polymer precursor. The patterned polymeric layer is formed by exposing the polymer precursor to light (typically ultraviolet light) though a photomask. Polymerization occurs in the areas of the liquid exposed to the light, while those areas masked by the photomask do not polymerize and remain in the liquid state. In an embodiment, polymerization occurs through the thickness of the liquid layer. In another embodiment, polymerization does not occur through the thickness of the liquid layer. Therefore, exposure of the liquid to the light results in polymerization of one or more regions of the liquid layer. Removal of the unpolymerized liquid leaves the patterned polymeric layer on the substrate.

In embodiments of the methods of the invention, the liquid mixture is confined between the substrate and a photomask, forming a liquid layer. Contact between the liquid and the photomask yields better pattern definition and resolution than if a thin layer of air or a layer of another material were present between the liquid and the photomask. The mask contact also serves to define an upper limit to the layer being produced, ensuring a level surface, if the mask is planar, and a 3D surface if the mask has topography. For example, ridges on the contact side of the mask produce shallow trenches in the polymerized layer while non transparent features on the mask form channels that extend through the entire layer. This makes it possible to build a fluidic structure and produce surface features in a single step. Also, contact between the liquid and the photomask can allow for a closed curing environment reducing atmospheric oxygen inhibition.

A 3D polymeric device, including a 3D microdevice, can be created by formation of multiple polymer layers upon the substrate. A sacrificial material can be used to protect features formed in each layer before formation of the next layer, with the sacrificial material being removed after completion of the device. The methods of the invention thus allow the production of undercut geometries without individual component assembly, allowing for 3D geometries as well as unattached structures (i.e. movable components).

Incorporation of one or more iniferters or iniferter precursors into the liquid(s) used to make a multilayered polymeric device ensures covalent bonding between layers, thus allowing formation of a monolithic device even when the polymer layers are of different chemical composition. Incorporation of an iniferter or iniferter precursor also allows modification of device surfaces, by allowing grafting of another monomer.

Embodiments of the invention also provide an apparatus for photolithographic fabrication of at least one polymer layer from a layer of a liquid comprising a polymer precursor. In an embodiment, the apparatus comprises a source of light and a reaction chamber. The reaction chamber contains the polymer precursor during polymerization process and allows the light into the chamber. The chamber comprises a first and a second enclosing element opposite one another. Embodiments of the apparatus allow adjustment and measurement of the separation between the first and second enclosing element, thereby allowing control of the thickness of the liquid layer within the polymerization chamber. Embodiments of the apparatus also allow adjustment and measurement of the alignment of the first and second enclosing elements. The ability to align the first and second enclosing elements relative to one another allows alignment of the photomask with a pattern produced in a previous polymerization step.

### BRIEF DESCRIPTION OF THE FIGURES

FIG. 1 schematically illustrates a method for fabricating a patterned polymeric layer.

FIG. 2 schematically illustrates use of iniferters for grafting and adhesion between polymeric layers.

FIG. 3 schematically illustrates an angled profile in a polymeric film formed with a 3D photomask.

FIG. 4 is a schematic for transfer of a previously polymerized layer.

FIG. 5 is a schematic illustration of formation of a channel structure.

FIGS. 6A-6D show an exemplary apparatus for fabrication of photopolymeric devices.

FIG. 7 contains an example of liver cell culture wells fabricated in parallel by the methods of the invention.

FIG. 8 shows the incorporation of a polymerizable, conductive, silver paste within a crosslinked network that has voids for a battery (left) and an analyte fluid reservoir (right).

FIG. 9, upper image, shows a device that contains a conductive carbon filament, which provides heating when a voltage is applied. FIG. 9, lower image, is of a thermotropic liquid crystal film which indicates spatially-resolved heating of the device.

FIG. 10 illustrates a fluid-driven cogwheel fabricated with the methods of the invention.

FIG. 11A illustrates a cross-sectional view of the cogwheel device of FIG. 10 and FIG. 11B illustrates the different masks used to form the device.

### DETAILED DESCRIPTION OF THE INVENTION

The present invention provides methods and apparatus for fabricating polymeric layers and 3D polymeric devices, including microdevices. The polymeric layers of the invention typically have a thickness between about 5 and about 5000 microns, preferably between about 20 and about 2000 microns. The polymeric layer may be patterned so that the thickness of the film is not uniform across the area of the film. For example, if the polymeric layer has been patterned to contain a trench, the thickness of the film will be zero inside the trench. A patterned polymeric layer need not be continuous, since it may contain features like trenches. A layer can also be a composite layer containing more than one material. For example, a layer can contain conductive “wires” in a non-conductive matrix. The term “polymeric” includes copolymers. “Copolymers” are polymers formed of more than one polymer precursor.

In particular, the invention provides a method for making a polymeric layer on a substrate comprising the steps of:
a) forming a layer of a liquid comprising a photopolymerizable polymer precursor between the substrate and an at least partially transparent element;
b) exposing the liquid layer to light through the at least partially transparent element, thereby polymerizing one or more regions of the liquid layer to form a polymeric layer; and
c) removing any unpolymerized region or regions of the liquid layer.

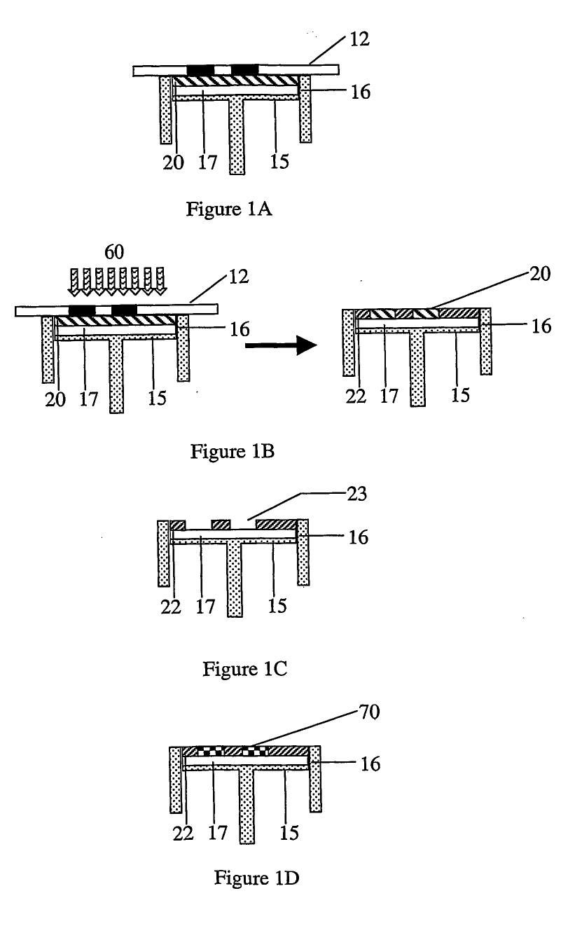

Steps a through c are schematically illustrated in FIGS. 1A-1C. In FIGS. 1A-1C, a reaction chamber is formed by base (15), side walls (16) and photomask (12). In FIG. 1A, a layer of a liquid (20) comprising a photopolymerizable precursor is formed between substrate (17) and photomask (12). The thickness of the liquid layer is adjusted prior to flood exposure. In FIG. 1B, the liquid layer (20) is exposed to light (60) through photomask (12), thereby polymerizing one or more regions of the liquid layer to form polymeric layer (22). In FIG. 1C, unreacted liquid (20) is removed from the cured film (22). For the photomask pattern illustrated in FIG. 1B, the cured film contains trenches (23).

Optionally, one or more of the trenches, depressions, or void volumes in the cured film can be filled with a sacrificial material (70) to prepare a level surface, as shown in FIG. 1D. The steps shown in FIGS. 1A-1C or 1A-1D can be repeated for each material to be fabricated in a given layer and/or for each subsequent layer. If the steps are repeated to fabricate a subsequent layer, the subsequent liquid layer is generally formed at least in part between the previously formed layer and an at least partially transparent element. Generally, the reaction chamber is readjusted for each subsequent layer. Typically, readjustment of the chamber involves adjusting the depth of the chamber. Readjustment of the chamber may also involve changing the photomask being used. After fabrication is complete, the devices can be released from the substrate, and void regions can be cleared by removal of the sacrificial material.

The liquid comprises a polymer precursor. If a polymer precursor that polymerizes photochemically is used (photosensitive polymer precursor), a separate photoinitiator does not need to be used. Otherwise, the liquid additionally comprises a photoinitiator. The liquid can also comprise additives, including, but not limited to, additives for bubble destabilization, additives for control of flow properties, and combinations thereof.

“Polymer precursor” means a molecule or portion thereof which can be polymerized to form a polymer or copolymer. Polymer precursors include any substance that contains an unsaturated moiety or other functionality that can be used in chain or step polymerization, or other moiety that may be polymerized in other ways. Such precursors include monomers and oligomers. Precursors suitable for use with the present invention are photopolymerizable. As used herein a photopolymerizable precursor is one that is capable of being polymerized by photoradiation, either ultraviolet (UV) or visible light. Examples of photosensitive polymer precursors include tetramercaptopropionate and 3,6,9,12-tetraoxatetradeca-1,3-diene. Some examples of precursors which are useful in the present invention include acrylates, methacrylates, styrenics, maleimides, vinyl ether/maleate mixtures, vinyl ether/fumarate mixtures, vinyl ether maleimides and thiol-ene mixtures in conjunction with a dissolved photoinitiator.

Photoinitiators that are useful in the invention include those that can be activated with light and initiate polymerization of the polymer precursor. Photoactive compounds useful in the invention include iniferters, iniferter precursors, non-iniferters, photocleavable initiators, and combinations thereof.

An iniferter is a molecule which functions as an initiator, transfer agent, and terminator during free radical polymerization. An iniferter precursor is a molecule which forms an iniferter after it terminates once. Either an iniferter or an iniferter precursor may be incorporated into the liquid comprising the polymer precursor. Preferred iniferter precursors are those which dissociate at the appropriate wavelength of light. Preferred iniferter precursors include tetraethylthiuram disulfide (TED) and tetramethylthiuram disulfide (TMD). Iniferters suitable for used with the invention include, but are not limited to p-xylene bis(N,N-diethyldithiocarbamate) (XDT) and other compounds containing diethyl- or dimethyldithiocarbamate moieties. Finally, other chemistries, which may act as iniferters (e.g., sulfides, phenylazo compounds, amines, alkoxyamines, halides, thiols, peroxides, disulfides, and tetraphenylethanes, etc.) and exhibit photoactivity, may be used with this invention.

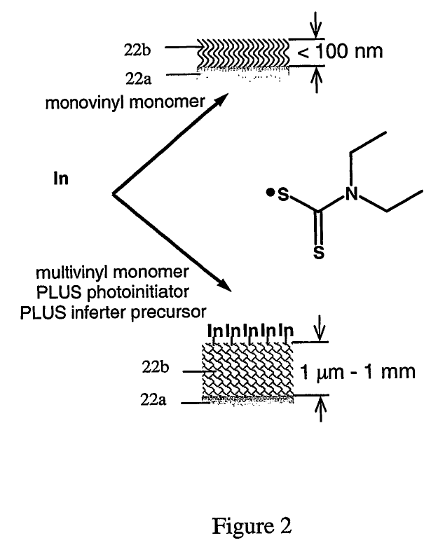

The chemical groups resulting from photocleavage of the iniferter precursor and growing polymer chains are reinitiable upon subsequent exposure to light (living radical character). When incorporated in the liquid, the resulting polymeric layer contains iniferter precursor at the surface as well as in the bulk, as schematically illustrated in FIG. 2. As shown in the upper portion of FIG. 2, use of an iniferter enables grafting of other chemical groups to the surface of the polymeric layer. FIG. 2 illustrates initiation of an iniferter-containing surface in the presence of pure monovinyl monomer, yielding polymer grafted to the surface. Specifically, layers formed from monomer formulations containing iniferter precursors have photocleavable groups (i.e., dithiocarbamate moieties, DTC) at their surfaces that initiate polymerization of other monomers upon illumination. (Sellergren, B. et al., A. J. Advanced Materials 14, 1204-1208 (2002), Otsu, T. Journal of Polymer Science Part A—Polymer Chemistry 38, 2121-2136 (2000), Ward, J. H. et al. Journal of Biomedical Materials Research 56, 351-360 (2001), Luo, N. et al. Journal of Polymer Science Part A—Polymer Chemistry 40, 1885-1891 (2002), Luo, N., et al. Macromolecules 35, 2487-2493 (2002)). A variety of monomers have been incorporated in this manner, yielding hydrophilic or hydrophobic surfaces, as well as surfaces with a high ionic content suitable for driving electro-osmotic flow. In the case of initiating monovinyl monomers from a DTC-containing surface, the radiation dose controls the concentration of the surface grafted polymer (Luo, N. et al. Journal of polymer Science Part A—Polymer Chemistry 40, 1885-1891 (2002), Luo, N., et al. Macromolecules 35, 2487-2493 (2002)). In fact, strict control of the grafted polymer architecture is not facilitated by the photoiniferter method. (Luo, N. et al. Journal of Polymer Science Part A—Polymer Chemistry 40, 1885-1891 (2002), Luo, N., et al. Macromolecules 35, 2487-2493 (2002)). Nonetheless, controlled polymerization is less important than the ability to photoinitiate polymerization of macromolecules that are covalently linked to the surface independent of its bulk chemistry.

In an embodiment, grafting is performed by depositing a liquid layer containing a polymer precursor of the material to be grafted on the surface of a previously formed layer. The previously formed layer has iniferter precursor groups at its surface. The liquid containing a polymer precursor preferably does not contain a photoinitiator, iniferter or iniferter precursor. The liquid layer is then exposed to light and polymerization is initiated at the surface of the previously formed layer. In an embodiment, polymerization does not occur through the thickness of the liquid layer.

As shown in the lower portion of FIG. 2, use of an iniferter enables covalent bonding and therefore improved adhesion between polymeric layers. For example, reinitiating by activation of DTC-containing surfaces in the presence of a monomer mixture composed of multivinyl monomers and additional initiator facilitates covalent adhesion between adjacent crosslinked layers. This process requires that the rate of surface initiation is rapid enough, relative to the bulk polymerization, to generate sufficient covalent linkages to the previous layer prior to complete curing of the new layer.

Preferred photocleavable photoinitiators form two active radical fragments. Preferred photocleavable initiators include phosphine oxides and phenones and quinones in combination with a hydrogen donor. Cationic initiators are also useful in the invention. Preferred cationic initiators include aryldiazonium, diaryliodonium, and triarylsulfonium salts. Preferred initiators include, but are not limited to, Rose Bengal (Aldrich), Darocur 2959 (2-hydroxy-1-[4-(hydroxyethoxy)phenyl]-2-methyl-1-propanone, D2959, Ciba-Geigy), Irgacure 651 (2,2-dimethoxy-2-phenylacetophenone, 1651, DMPA, Ciba-Geigy), Irgacure 184 (1-hydroxycyclohexyl phenyl ketone, 1184, Ciba-Geigy), Irgacure 907 (2-methyl-1-[4-(methylthio)phenyl]-2-(4-morpholinyl)-1-propanone, 1907, Ciba-Geigy), Camphorquinone (CQ, Aldrich), isopropyl thioxanthone (quantacure ITX, Great Lakes Fine Chemicals LTD., Cheshire, England), Kip 100 and 150 from Fratelli-Lamberti, Darocur 1173 2-Hydroxy-2-methyl-1-phenyl-propan-1-one (Ciba Specialty Chemicals), and phosphine oxides such as Irgacure Bis(2,4,6-trimethylbenzoyl)-phenylphosphineoxide 819 (Ciba). CQ is typically used in conjunction with an amine such as ethyl 4-N,N-dimethylaminobenzoate (4EDMAB, Aldrich) or triethanolamine (TEA, Aldrich) to initiate polymerization.

In embodiments of the methods of the invention, the liquid comprising a polymer precursor is confined between a substrate and an at least partially transparent element, forming a liquid layer. The liquid may be bounded by a solid surface only on two opposing sides. Therefore, it is not required that the liquid be introduced into a channel in a substrate.

However, if the liquid is substantially enclosed by a reaction chamber, oxygen inhibition can be reduced. Sources of oxygen include oxygen present in the polymer precursor and oxygen present in the surroundings during polymerization. By enclosing the liquid, the oxygen supply from the surroundings is limited. The oxygen supply from the surroundings can be further limited by supplying an inert gas to the enclosure. An overpressure of inert gas may be used. Oxygen inhibition can also be reduced by purging the polymer precursor with an inert gas before use. However, some amount of oxygen inhibition due to oxygen distributed in the polymer precursor can lead to better aspect ratios. (Madou, Fundamentals of Microfabrication: The Science of Miniaturization, CRC Press, Boca Raton, 1997)

Contact between the liquid and the photomask yields better pattern definition and resolution than if a thin layer of air or a layer of another material were present between the liquid and the photomask. For example, the presence of a thin layer of air between the substrate and the mask in non-contact mode diffracts parallel UV-light, making sharp intensity transitions between shaded and transparent regions difficult to attain.

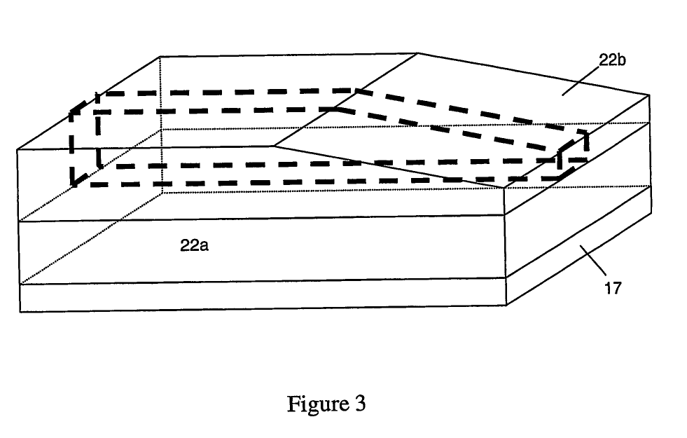

The mask contact also serves to define an upper limit to the layer being produced, ensuring a level surface, if the mask is planar, and a 3D surface if the mask is not planar. The photomask may have a topographic pattern on its inner surface, such as a pattern of ridges. The photomask may also have 3D surface so that the polymeric layer has an angled or non-level profile. FIG. 3 schematically illustrates a sloped polymeric layer (22b) made using a photomask with a 3D surface. As shown in FIG. 3, the sloped layer (22b) is formed on top of a previously formed layer (22a) and a substrate (17). Non-planar photomasks may be constructed by patterning a transparent material placed on the inner surface of the photomask or by micromachining the photomask. Use of non-planar photomasks makes it possible to build a fluidic structure and produce surface features in a single step.

Having the photomask in contact with the liquid can also allow for transfer of chemical compounds that are immiscible in the polymeric precursor. In an embodiment, the photomask is coated with a self assembled monolayer or a very thin layer of a chemical compound that has one segment that will yield the desired surface properties, and another segment that contains a polymerizable group. Due to phase separation the immiscible portion of the molecule will face the mask, and the polymerizable group will be in molecular contact with the liquid polymeric precursor. Upon exposure to light, the polymerizable group will copolymerize with the matrix material, forming an even surface modification. This method of surface modification can be used for flat surfaces such as base layers that later form channel bottoms.

In another embodiment, the photomask is coated with a “functional layer” containing functional compounds, such as magnetic or conducting particles. To ensure that the functional layer is transferred from the mask to the device, the functional layer can be melted. Removal of the mask leaves the functional material on the side facing the mask. In an embodiment, the functional material is a thin layer which is deposited on the surface of the device. If so desired, these sites can be sealed with a layer of polymer.

Preferably, the materials for the substrate and the at least partially transparent element are selected so that the polymerized polymeric film can be easily removed. Preferably, the substrate material is sufficiently rigid to protect the polymeric structures made with the process. In an embodiment, a separate substrate is attached to an enclosing element of the reaction chamber. Useful materials for the substrate in this embodiment, include, but are not limited to sheets of thermoplastic materials such as polycarbonate, Plexiglas (PMMA), polypropylene and polystyrene. The substrate can also be formed by an enclosing element of the reaction chamber, in which case useful substrates, include, but are not limited to, metals. During fabrication of multilayer structures, a previously fabricated layer can serve in least in part as the substrate for a layer to be deposited. If the previously formed layer is patterned, the substrate for the layer to be deposited may also be formed in part by sacrificial material used to fill voids in the previously formed layer. If the previously formed layer contains features like trenches which have not been filled with sacrificial material, the substrate for the previously formed layer may also act in part as the substrate for the material to be formed.

As used herein, an “at least partially transparent element” is at least partially transparent to wavelengths of light useful for the invention. In particular, the at least partially transparent element may be transparent to UV and/or visible light. Typically, the at least partially transparent element will be a partially transparent photomask. The photomask pattern may be a frame. However, in some cases it may be desirable that the at least partially transparent element be wholly transparent. The photomask may be of any type known to the art, including chrome on quartz/glass, ink on a polymer sheet, or a dynamic mask where electrical signals change a liquid crystal display making CAD control possible. If the photomask is made of sufficiently rigid material (e.g. chrome on glass), the photomasks may form an enclosing element of the reaction chamber. The photomask may have transparent 3D features on the contact side. Preferably these features are made of materials and dimensions such that the polymeric layer can be released from the mask without destruction of the layer. The features may be formed from the photomask or be separate features attached to it. Suitable materials for forming 3D features on contact side of the photomask include but are not limited to waxes, previously formed polymeric layers, thermoplastic structures, and glass structures. Some of these materials can be glued to the photomask. If finer features than 50 microns are desired, then a chrome on glass mask may be used. The 3D features may remain on the photomask after the photomask is removed are be transferred to the polymeric layer. For improved resolution of the pattern, the pattern side of the photomask is placed in contact with the liquid comprising the polymer precursor.

The liquid layer is exposed to light through the photomask. The wavelengths and power of light useful to initiate polymerization depends on the initiator used and/or the wavelength (or wavelengths) that will activate the photosensitive precursor. A combination of photosensitive precursor(s) and photoinitiator(s) may be used. Light used in the invention includes any wavelength and power capable of initiating polymerization. Preferred wavelengths of light include ultraviolet or visible. Any suitable source may be used, including laser sources. The source may be broadband or narrowband, or a combination. Wavelengths used are typically from a mercury light bulb's emission lines. Initiators are usually tailored to the 365 nm line, but they are also sensitive to 311 and 313 lines. Special initiators have been developed for pigmented systems, and they usually absorb well around 400 nm (usually these are phosphine oxides such as Irgacure 819).

The desired power level depends on the composition of the mixture to be cured and the desired cure time. Higher power can lead to a shorter cure time. Higher power can also reduce the amount of initiator in the formulation, leading to a more even exposure of the precursor with respect to the thickness. This can be an important variable when relatively thick layers are considered. Suitable power levels include, but are not limited to 10-1000 mW/cm², 10-500 mW/cm², 10-100 mW/cm², 25-100 mW/cm², and 50-70 mW/cm².

In an embodiment, the light is substantially collimated. In an embodiment, the substantially collimated light enters the at least partially transparent element at an angle of substantially ninety degrees. In another embodiment, the light is not substantially collimated. The desired degree of collimation depends on the thickness of the polymeric layer and tolerances required in the pattern formed. For example, if the polymeric layer is thin and the tolerances required relatively large, the light need not be substantially collimated.

The liquid layer is exposed to the light for sufficient time to polymerize the unmasked portions of the layer. The time for which the liquid layer is exposed to the light depends in part upon the types and kinds of photoinitiator used. In different embodiments, polymerization of the liquid layer is complete within about 10 s, 30 s, 1 minute, 5 minutes and 10 minutes.

The maximum thickness of the polymeric layer depends upon the polymeric precursor selected and the desired resolution of the pattern. The lower the attenuation of the UV light, the lower the optical density and the greater the thickness that can be obtained for a given resolution.

During the polymerization process, exposure of the liquid to the light results in polymerization of one or more regions of the liquid layer. Typically the polymer precursor and light source are selected so that polymerization of a given region results in polymerization through the thickness of the layer.

The unpolymerized liquid may be separated from the polymerized patterned layer by a number of methods. These methods include, but are not limited to: blotting, rinsing, using pressure or vacuum, or combinations thereof.

The methods of the invention also permit incorporation of more than one polymer material in a given layer (composite polymeric layers). For example, it is possible to polymerize one section of the layer and then with the same thickness setting but with a different mask and polymer precursor polymerize another section. Depending on the configuration of features in the layer, it may be useful to use a sacrificial material to protect cavities in the first-deposited polymeric layer from being filled by the liquid containing a subsequent polymer.

It is possible to fabricate one-layer devices composed of multiple materials that are seamlessly integrated. In an embodiment, the multiple materials are integrated by means of an iniferter or iniferter precursor in the liquid containing the polymer precursor. The use of an iniferter or iniferter precursor in the liquid ensures good covalent bonding between the materials. The iniferter makes it possible to couple materials that would not copolymerize due to adverse radical properties (electron or spin densities). In this case the reactive radical site would be the material polymerized first, followed by the iniferter. The monomer with the functionality that will form the less reactive radical is then introduced, coupled to the matrix using the normal procedure, and can then homopolymerize to form a graft. In this manner it is possible to have a resilient polymer as a protective layer around the finished device, while more fragile structures are in the interior. For example, these materials can be electrically conducting, which allows for incorporation of specialized semiconductor devices and heating units.

The methods of the invention also allow the integration of specialized structures into a layer. For example, a filter can be incorporated into a patterned layer by placing the filter, as well as the liquid, in the space between the photomask and the substrate. Polymerization of the liquid using the methods of the invention allows patterning of the polymeric layer.

The invention provides a variety of methods for making 3D devices and microdevices. The 3D polymeric devices of the invention comprise one or more polymeric layers, generally including at least one patterned polymeric layer. As used herein, a polymeric microdevice has at least one feature which has at least one dimension less than about 1000 microns.

In one embodiment, a multilayered device can be constructed by building the device one layer at a time. In another embodiment, a multilayered device can be constructed by attaching a previously made feature to the contact side of the photomask, and transferring it to a layer being formed. In another embodiment, a multilayered device is constructed by separately finishing two halves of the device and attaching them together as a last step. Combinations of these methods may also be used to build devices.

The methods of the invention can be used to make 3D devices through assembly of multiple layers. In an embodiment, subsequent layers can be formed on each other to build up the 3D structure. In this process, cavities such as trenches, depressions or void volumes in a layer are generally filled with a sacrificial material before a subsequent layer is attached. The sacrificial layer ensures that no liquid polymer precursor can access portions of the device where a polymer would obstruct flow, etc. Any excess sacrificial material deposited onto surfaces where attachment of the subsequent layer can be solvent polished before fabrication of the subsequent layer. This step can be repeated many times throughout the fabrication of the device, enabling true 3D structures regardless of the geometries of individual layers. In this process, it may be desirable that one or more of the layers is not patterned, which can be accomplished by using a blank photomask or a photomask patterned only to provide a frame.

Sacrificial materials useful for the present invention are those that form a solid barrier to liquids and can be preferentially removed by changing the ambient conditions (magnetic, temperature, solvent, chemical, pH etc. etc). Suitable sacrificial materials include those that become liquid upon heating, simplifying their removal. The temperature at which the sacrificial material becomes liquid should be low enough so that none of the polymeric materials are damaged by the sacrificial material removal process. Sacrificial materials useful for the present invention include, but are not limited, to waxes. Specifically, an embodiment of the invention provides a method for forming a three-dimensional polymeric device on a substrate comprising the steps of:
a) forming a first layer of a first liquid comprising a first polymer precursor between the substrate and a first at least partially transparent element;
b) exposing the first liquid layer to light through the first at least partially transparent element, thereby polymerizing at least a region of the first liquid layer to form a first polymeric layer
c) removing any unpolymerized region or regions of the first liquid layer;
d) removing the first at least partially transparent element;
e) forming a second layer of a second liquid comprising a second polymer precursor at least in part between the first polymeric layer and a second at least partially transparent element;
f) exposing the second liquid layer to light through the second at least partially transparent element, thereby polymerizing at least a region of the second liquid layer to form a second polymeric layer; and
g) removing any unpolymerized region or regions of the second liquid layer.

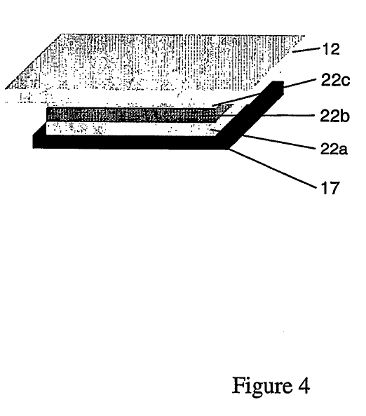

In an embodiment, a 3D device can be constructed by transferring permanent features from the contact side of the mask to the finished device. Permanent features which may transferred in this manner are those that are transparent, can be non permanently attached to the mask, and then transferred to the device with a light-activated adhesive. Permanent features which can be transferred include, but are not limited to, previously formed polymeric layers, thermoplastic structures, and glass structures. Previously formed polymeric layers may be attached to the mask by using the mask as a substrate in a previous exposure step. This method is schematically shown in FIG. 4. In this method the bottom layer of the device (22a) is polymerized onto the substrate (17), and the third layer (22c) is polymerized onto a mask (12) where the pattern of the mask corresponds to the second layer. The setup consists of a bottom layer, unpolymerized precursor with a defined thickness, third layer attached to the contact side of the mask. Upon polymerization through the mask, the second layer (22b) is formed, covalently attached to the adjacent layers. Uncured polymer is easily rinsed away from the second layer since the second layer features are invariably accessible from the outside. In the setup shown in FIG. 4, the photomask is not in contact with the liquid which is polymerized to form the second layer (22b). For better resolution of features in layer (22b), layer (22c) should be optically thin and have a similar refractive index to that of the polymer precursor. However, it is not very different to have a previously polymerized layer on top forming a combined thickness of 500 microns, compared to a single layer of 500 microns. The features in the bottom portions should have the same resolution. To form a thicker layer as the top, an additional top layer can be formed using the same photomask.

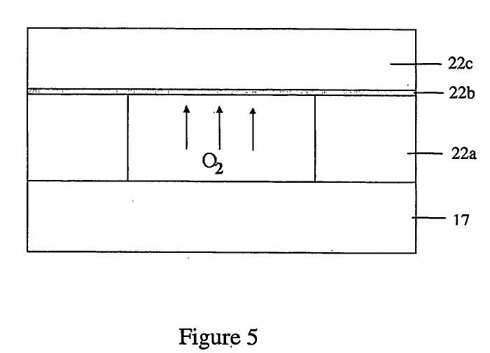

Another method for fabricating 3D devices is to separately finish two halves of the device and attach them to each other as a last step. This can be accomplished by forming the layers to be joined from a liquid containing an iniferter or iniferter precursor, as well as a polymer precursor, thereby generating active surface groups on the surface of the layers to be joined. A liquid polymer precursor that contains little or no photocleavable initiators can be used as an adhesive to join the two layers. A thin film of this material is spread on one of the halves of the device and the other half is aligned to it. This is very similar to the process depicted in FIG. 4. The differences are that the mask can be completely featureless, layer (22b) is very thin and layer (22a) and (22c) can actually be multilayer features. Upon flood lighting of this assembly, the polymer precursor polymerizes where the surfaces are in contact, and wherever there is a gap, e.g. a channel structure in one of the halves, oxygen inhibition ensures that no curing takes place. Excess liquid is then rinsed away from the channels, resulting in no build up of polymer in channel features, thus retaining the intended dimensions. FIG. 5 schematically illustrates formation of a channel structure according to this method.

In an embodiment, a multilayered device is fabricated using an iniferter or iniferter precursor in the liquid used to form one or more layers. The covalent bonding ensured by the iniferter can be beneficial because the layer to layer contacts may occur over a relatively a small area for patterned layers (for example, a thin enclosing element separating two channels or a post with a high aspect ratio bonding to an adjacent layer) compared to a full layer placed on top of another layer. If the liquid comprises an iniferter precursor, it is preferred that the liquid further comprises a photoinitiator. If the liquid comprises an iniferter, a photoinitiator may or may not be used. In another embodiment, covalent adhesion between adjacent layers is achieved by covalently coupling photoinitiator chemistry to the first layer surface prior to introduction of the polymer precursor for the subsequent layer. In this manner, the photoactive species, which is responsible for generating radicals that propagate into the subsequent layer, becomes available via an extra process step (i.e., photoinitiator coupling).

The invention also provides an apparatus for photolithographic fabrication of a photo-polymerized layer from a layer of a liquid comprising a photopolymerizable polymer precursor, the apparatus comprising:
a) a source of light; and
b) a reaction chamber for containing the liquid layer, the chamber comprising a first and a second enclosing element, the first enclosing element comprising an at least partially transparent element placed in the path of the light and contacting the liquid within the chamber, the second enclosing element of the chamber being opposite to the first enclosing element.

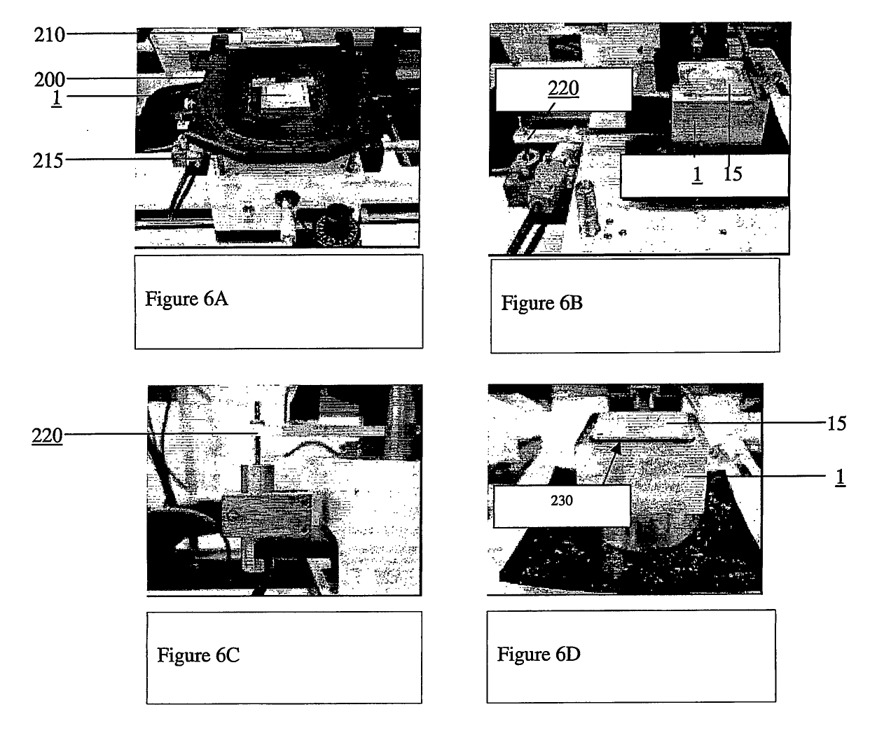

The reaction chamber has at least a first enclosing element and a second enclosing element opposite the first enclosing element. In an embodiment, the reaction chamber does not substantially enclose the liquid layer. For example, the first enclosing element can be a top glass plate with an attached photomask and the second enclosing element can be a bottom metal plate. The top glass plate can be supported on a structure which, in combination with the top and bottom plates, does not substantially enclose the liquid layer. For example, the top glass plate can be attached to a conventional photomask holder which is supported by a hinge and two posts (See FIG. 6A). A substrate may be attached to the second enclosing element.

In another embodiment, the reaction chamber does substantially enclose the liquid layer. By substantially enclosing the liquid layer, it is meant that the chamber limits oxygen flow into the chamber from the surroundings and/or liquid flow out of the chamber. A complete seal need not be formed between each of the walls of the reaction chamber in order for the reaction chamber to substantially enclose the liquid layer. The reaction chamber may enclose the liquid by any means known to those skilled in the art. For example, an o-ring may be placed between the first and second enclosing element. The reaction chamber can also be formed of rigid walls which substantially enclose the liquid layer.

In an embodiment, the first and the second enclosing element of the chamber are substantially parallel to one another. By substantially parallel, it is meant that the first and second enclosing elements are sufficiently parallel that the thickness variation across the area of the device falls within tolerance limits. In another embodiment, the first and second enclosing element are not substantially parallel to one another, which case the polymerized film is not uniform in thickness.

In an embodiment, the first enclosing element comprises an at least partially transparent element which is placed in the path of the light during photopolymerization. In an embodiment, the at least partially transparent element comprises a partially transparent photomask. The at least partially transparent element contacts the liquid within the chamber. Typically, the liquid forms a layer between the photomask and a substrate attached to the opposite enclosing element of the chamber. The substrate can be attached to the chamber enclosing element with an adhesive, pressure (e.g. vacuum), magnetism or chemical bonding. The liquid can also form a layer between the photomask and the opposite enclosing element of the chamber without an additional substrate being used.

The photolithographic mask may be a separate mask attached to the first or second enclosing element of the chamber. In this embodiment, the mask need not be rigid and can be attached to the chamber enclosing element with an adhesive. Suitable adhesives allow the mask to be removed from the chamber enclosing element as desired and include photopolymerizable compounds. Alternatively, the photomask may comprise part or all of the chamber enclosing element. In this embodiment, the photomask should sufficiently rigid to define the upper surface of the liquid layer.

In an embodiment, the separation between the first and second enclosing element is adjustable. Means for adjusting of the separation between the first and second enclosing element can be accomplished by fixing the position of one of the first and second enclosing element, and attaching the other opposing enclosing element to a positioning device. For example, the second enclosing element may be attached to a micropositioner or positioned on shims.

The apparatus also can provide means for measurement of the separation of the first and second enclosing element of the chamber. Since the separation between the first and second enclosing element of the chamber is related to the thickness of the liquid layer inside the reaction chamber, the apparatus allows control of the thickness of the liquid layer. A variety of devices may be used to measure the separation of the first and second enclosing element, including LVDT sensors. For example, the thickness of the liquid layer may be determined as follows: a substrate is placed on a movable bottom plate of the apparatus and a photomask is placed on the top plate of the apparatus. The substrate is raised until the top of the substrate contacts with the mask, and the position in the height direction of the substrate is recorded through the use of LVDT sensor(s), giving an accurate reading of the position of the top of the substrate. The bottom is lowered until there is a gap formed between the top of the substrate and the mask plane, thus defining the thickness of the layer that is going to be produced.

The apparatus can provide means for alignment of the first and second enclosing element. The adjustment of the relative alignment results in substantially in-plane displacement of one enclosing element relative to another. The apparatus can also allow alignment of elements attached to the first and second enclosing element, such as a photomask and a substrate and a photomask and a patterned layer attached to a substrate. If during alignment the position of the first enclosing element is changed, the first enclosing element moves substantially in the plane defined by the first enclosing element. Means for alignment include attaching one of the plates to an appropriate positioning device. Means for measuring the alignment includes a microscope and automated alignment systems that automatically align to previously formed features.

The chamber allows the introduction of the liquid into the chamber. In an embodiment, the liquid is introduced when the chamber is disassembled. For example, the liquid may be placed on a substrate placed on a bottom enclosing element. The chamber is then assembled by placing the top enclosing element (comprising a photomask) in position. In another embodiment, the chamber need not be disaassembled and the monomer can be directed through one or more inlets into the chamber.

Similarly, the chamber allows the removal of the liquid. In an embodiment, the unpolymerized liquid is removed by removing the first enclosing element. In another embodiment, the chamber is not disassembled and the unpolymerized liquid can be directed through one or more outlets from the chamber.

The chamber also allows the removal of the polymerized layer(s) when the polymerization process is complete. Typically, the first enclosing element is removed to remove the polymerized layer, although any other means known to those skilled in the art may be used to remove the polymerized layer or device. The layer or device is typically fabricated on a removable plate to simplify removal of the layer or device.

In an embodiment, the apparatus comprises a reaction chamber having a transparent top enclosing element and a bottom enclosing element. A source of UV light is placed above the reaction chamber. A photomask is attached to the inside of the top enclosing element. The separation of the top and bottom enclosing element is controlled by fixing the position of the top enclosing element, attaching the bottom enclosing element to a pedestal with x, y, and z positioning controls, and adjusting the z control. The aligrnent of the top and bottom enclosing element is controlled by adjusting the x and y controls.

The reaction chamber can be equipped with vacuum and purge connections to better reduce oxygen levels in the chamber. The reaction chamber can also be equipped with heating and/or cooling coils to reduce the time it takes to add and remove sacrificial material layers, to reduce the effects of unwanted thermal curing while photopolymerizing monomer solutions, and to enable unpatterned thermally curable polymer layers to be deposited as well as photocurable polymer layers. The reaction chamber can also be equipped with inlets and outlets for the liquid containing the polymeric precursor, the sacrificial material, and/or solvent for cleaning.

Those of ordinary skill in the art will appreciate that other materials, procedures and apparatus other than those specifically disclosed herein can be applied to the practice of this invention without resort to undue experimentation. All such materials, procedures and apparatus are intended to be encompassed within the scope of this invention. Those of ordinary skill in the art will be aware of a number of materials, procedures and apparatus elements that are functionally equivalent to the materials, procedures and apparatus elements that are disclosed and/or described herein. All such functional equivalents are intended to be encompassed by the scope of this invention.

All references cited herein are herein incorporated by reference to the extent not inconsistent with the disclosure herein.

### EXAMPLES

### Example 1

### Apparatus for Fabrication of Photopolymeric Devices

The apparatus for photopolymeric device fabrication was based on a photolithography system from Optical Associates, Inc., San Jose, Calif. The original mask alignment system (Model 204) was equipped with micropositioners in the x, y, z, and theta directions. The opening in the mask holder of the original system was enlarged and the substrate holder (i.e., wafer chuck housing) replaced with a reaction chamber. An LVDT height measurement sensor also added (220 in FIG. 6B). The collimated flood exposure source used with the system provided 50 to 70 mW/cm² of 365-nm radiation.

FIGS. 6A-6D show an exemplary apparatus for fabrication of photopolymeric devices. FIG. 6A shows the photomask holder (200) which was supported at the back by a hinge (210) and at the front by two posts (215). The printed photomask (not shown) was attached to a glass plate (not shown) which was attached to the photomask holder with clamps. FIG. 6B illustrates the height measurement sensor and the reaction chamber. In FIG. 6B, mask holder (200) is rotated out of view. The reaction chamber (1), which was coupled to the original x-y translation system, contained an adjustable-depth well. The platform providing the adjustable bottom of the chamber (15) was coupled to the existing z-axis micropositioner, which had a travel length of about 5 mm, and a thickness resolution of about 10 microns. The reaction chamber was 1.3 by 1.3 in. (3.3 by 3.3 cm). When the photomask holder was rotated into position, the glass plate supporting the photomask contacted the top of the side walls of the reaction chamber. FIG. 6C illustrates the height measurement sensor at higher magnification. In FIG. 6D, the bottom of the chamber (15) is shown in the extended position and o-ring (230) is visible. The o-ring helps prevent the flow of liquid out of the chamber.

Another reaction chamber consisted of vertical stainless steel enclosing elements fixed to a bottom plate. Since the top and bottom of the chamber were both fixed, positioning in the z direction was accomplished by adjusting the number of shims (i.e., thin and flat spacers cut to fit within the walls of the chamber) supporting the substrate inside the chamber. To fabricate a number of layers, the chamber was loaded with a sequence of shims corresponding to the desired layer thicknesses. A polycarbonate substrate (also cut to fit within the walls of the chamber) was placed on this stack of shims, and the top shim was removed after each layer was polymerized to allow space for deposition and curing of the next layer.

### Example 2

### Fabrication of Photopolymeric Devices

A typical monomer formulation for structures included 1.5% (wt/wt) 1-hydroxycyclohexyl phenyl ketone (tradename: Irgacure 184, Ciba, Tarrytown, N.Y.) as the photoinitiator, 1.0% photoiniferter precursor, tetraethylthiuram disulfide (TED, Aldrich Chemical Co., Milwaukee, Wis.), and 1.0% acrylic acid (Aldrich), in a mixture of 50% (wt/wt) triethyleneglycol diacrylate (Sartomer, Exton, Pa.) and 50% hexavinyl aromatic urethane acrylate (EBECRYL 220, Sartomer). For multilayer structures, paraffin wax was used as a sacrificial material.

Typically, a polycarbonate substrate was attached to a metal bottom plate with a two-part epoxy. The metal plate was fixed to the adjustable bottom of the chamber with two or more machine screws. The photomask was printed on a transparency film and attached to a glass plate with a photosensitive adhesive. The glass plate was secured with the original mask clamps. The distance between the polycarbonate substrate, attached to the bottom plate, and the transparency film, clamped to the mask holder, was adjusted with the z-direction micropositioner. A pool of monomer was deposited onto the polycarbonate substrate and the hinged mask holder was lowered slowly until the mask was in contact with the monomer formulation and the top of the chamber walls (i.e., substantially enclosing the reaction chamber). Layers containing TED were exposed for about 4 min. to achieve maximum double bond conversion, which was about 85%.

Subsequent layers were fabricated in the same manner. Unreacted monomer, due to masking, was removed from each layer and void regions were filled with molten wax. Upon cooling, excess wax was removed by polishing with a small amount of solvent.

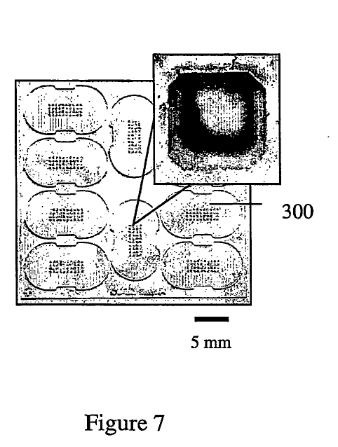

FIG. 7 contains an example of liver cell culture wells fabricated in parallel by the methods of the invention. The ten identical devices (300), containing 300-μm wells (see inset, FIG. 7), were fabricated by patterning a single layer directly onto a poly(vinylidene fluoride) (PVDF) filter with 5-micron pores.

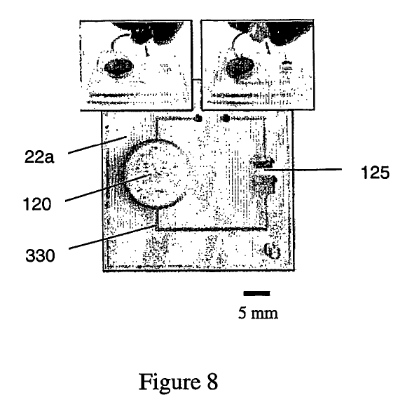

FIG. 8 shows the incorporation of a polymerizable, conductive, silver paste within a crosslinked network that has voids for a battery (left) and an analyte fluid reservoir (right). The first functional layer (22a) was fabricated from the typical monomer formulation with void regions for the battery, fluid reservoir, and conductive wires. Next, a silver-containing monomer formulation (UVAG 0010, Allied PhotoChemical, Kimball, Mich.) was used to fill the channels and pattern electrically-conductive wires (330) within specific regions of the device. The reservoir and battery chambers were masked to prevent curing of the conductive monomer formulation in these regions. Finally, the top layer, which was comprised of a typical monomer formulation, was deposited and cured through a mask that maintained voids for the battery (120) and the open fluid reservoir (125). In the upper left inset, the fluid reservoir is empty. In the upper right inset, the fluid reservoir is filled with electrolyte, activating the electrical switch. The scale marker shown is for the lower image rather than the insets.

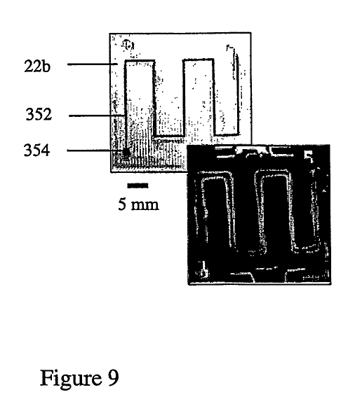

FIG. 9 shows a device that contains a conductive carbon filament, which provides heating when a voltage is applied. A thermotropic liquid crystal film, clamped to the device surface, reveals the spatial resolution of the heating (up to 90° C. with application of 115 V; see lower image, FIG. 9). The device was constructed of two layers with three different materials in the second layer. The first layer provided a flat surface containing photoiniferter groups. The second layer (22b) was formed by first masking and curing the typical monomer formulation to create a continuous serpentine channel. Then, the channel was filled with the polymerizable carbon formulation (7082, DuPont, Research Triangle Park, NC) and the central region was exposed, forming a conductive carbon filament (352). Finally, the electrical contact pads (354) at the ends of the filament were formed by filling the remaining voids with a silver-containing monomer formulation (UVAG 0010, Allied PhotoChemical, Kimball, Mich.) and subsequent flood exposure.

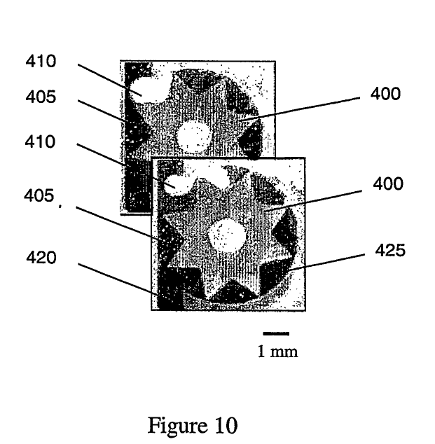

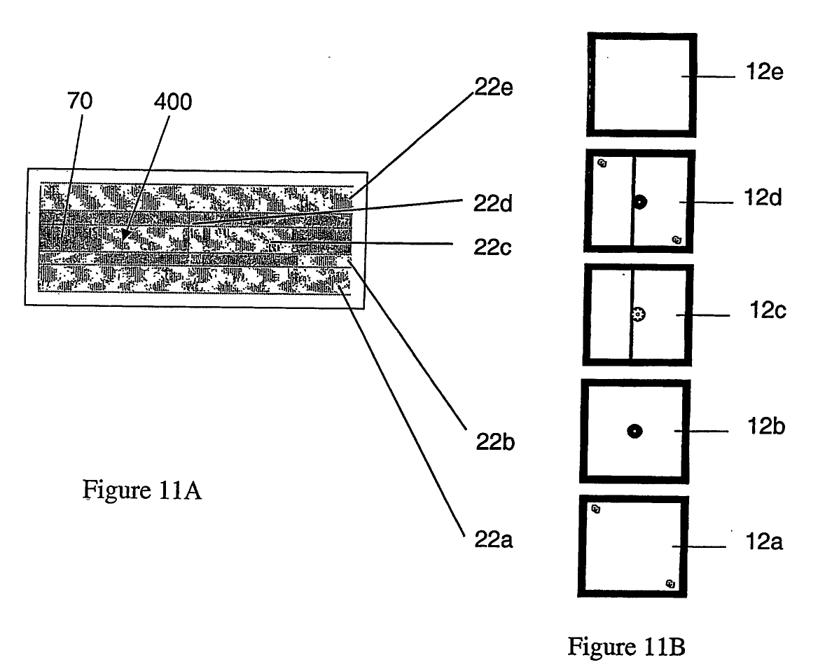

The fluid-driven cogwheel (400) in FIG. 10 demonstrates the utility of the invention for generating complex microdevice structures. In particular, independent, unattached parts are fabricated simultaneously in the same layer. Five layers, formed by masked photopolymerization of the typical monomer formulation, produce an enclosed device containing a cogwheel that rotates freely around a fixed post as fluid (405) flows through a channel (420) tangent to the wheel cavity (425). The use of sacrificial materials to maintain void regions during subsequent layer polymerization enables fabrication of designs that take advantage of the third dimension in space. The pictures in FIG. 10 reveal deformation of an air bubble (410) trapped in the driving fluid. FIG. 11A illustrates a cross-section through the diameter of the cogwheel and FIG. 11B the different masks used to form this device.

Images of structures, captured with transmission and top-down microscopes as well as digital macro photography, were enhanced digitally for optimal contrast, brightness, and color.

1. A method for making a polymeric layer on a substrate comprising the steps of:
a) forming a layer of a liquid comprising a photopolymerizable polymer precursor between the substrate and an at least partially transparent element;
b) exposing the liquid layer to light through the at least partially transparent element, thereby polymerizing one or more regions of the liquid layer to form a polymeric layer; and
c) removing any unpolymerized region or regions of the liquid layer.

2. The method of claim 1, wherein the at least partially transparent element is a photomask, and a patterned polymeric layer is formed.

3. The method of claim 1 wherein the at least partially transparent element has three-dimensional features on the side of the element which contacts the liquid.

4. The method of claim 1, wherein the liquid further comprises a photoinitiator.

5. The method of claim 1, wherein the liquid further comprises an iniferter or an iniferter precursor.

6. The method of claim 5, wherein the liquid further comprises a photoinitiator.

7. A method for forming a composite polymeric layer on a substrate comprising the steps of:
a) forming a first layer of a first liquid comprising a first polymer precursor between the substrate and a first at least partially transparent element, wherein the first at least partially transparent element is a photomask;
b) exposing the first liquid layer to light through the first at least partially transparent element, thereby polymerizing at least a region of the first liquid layer to form a patterned first polymeric layer having at least one unpolymerized region;
c) removing any unpolymerized region or regions of the first liquid layer, thereby forming at least one cavity;
d) removing the first at least partially transparent element;
e) filling at least one cavity of the first polymeric layer with a second liquid comprising a second polymer precursor, wherein the second polymer precursor is different from the first;
f) placing a second at least partially transparent element in contact with the second liquid and opposite to the substrate;
g) exposing the second liquid layer to light through the second at least partially transparent element, thereby polymerizing at least a region of the second liquid layer to form a patterned second polymeric layer; and
h) removing any unpolymerized region or regions of the second liquid layer.

8. The method of claim 7 wherein the first liquid further comprises a photoinitiator.

9. The method of claim 7 wherein the first liquid further comprises an iniferter or an iniferter precursor.

10. A method for forming a multilayered polymeric device on a substrate comprising the steps of:
a) forming a first layer of a first liquid comprising a first polymer precursor between the substrate and a first at least partially transparent element;
b) exposing the first liquid layer to light through the first at least partially transparent element, thereby polymerizing at least a region of the first liquid layer to form a first polymeric layer c) removing any unpolymerized region or regions of the first liquid layer;
d) removing the first at least partially transparent element;
e) forming a second layer of a second liquid comprising a second polymer precursor at least in part between the first polymeric layer and a second at least partially transparent element;
f) exposing the second liquid layer to light through the second at least partially transparent element, thereby polymerizing at least a region of the second liquid layer to form a second polymeric layer; and
g) removing any unpolymerized region or regions of the second liquid layer.

11. The method of claim 10 wherein at least one of the polymeric layers is a patterned polymeric layer.

12. The method of claim 10 further comprising filling one or more cavities in the first polymeric layer with a sacrificial material.

13. The method of claim 12 further comprising removing excess sacrificial material from the surface of the first polymeric layer prior to forming the layer of the second liquid.

14. The method of claim 10 wherein the first liquid further comprises an iniferter or an iniferter precursor.

15. The method of claim 10 further comprising the steps of
h) removing the previous element;
i) forming a subsequent layer of a subsequent liquid comprising a subsequent polymer precursor at least in part between the previous polymeric layer and a subsequent at least partially transparent element;
j) exposing the subsequent liquid layer to light through the subsequent at least partially transparent element, thereby polymerizing at least a region of the subsequent liquid layer to form a subsequent polymeric layer; and
k) removing any unpolymerized region or regions of the subsequent liquid layer.

16. The method of claim 15 further comprising filling one or more cavities in the previous polymeric layer with a sacrificial material before forming the layer of the subsequent liquid.

17. The method of claim 16 further comprising removing excess sacrificial material from the surface of the previous polymeric layer before forming the layer of the subsequent liquid.

18. The method of claim 15 further comprising repeating steps h through k until the desired number of polymeric layers is formed.

19. An apparatus for photolithographic fabrication of a photo-polymerized layer from a layer of a liquid comprising a photopolymerizable polymer precursor, the apparatus comprising:
a) a source of light; and
b) a reaction chamber for containing the liquid layer, the chamber comprising a first and a second enclosing element, the first enclosing element comprising an at least partially transparent element placed in the path of the light and contacting the liquid within the chamber, the second enclosing element of the chamber being opposite to the first enclosing element.

20. The apparatus of claim 19 wherein the second enclosing element of the chamber is substantially parallel to the first element.

21. The apparatus of claim 19 wherein the reaction chamber substantially encloses the liquid layer.

22. The apparatus of claim 19 further comprising means for adjusting the separation between the first and second enclosing elements.

23. The apparatus of claim 19 further comprising means for measuring the separation of the first and second enclosing elements of the chamber.

24. The apparatus of claim 19 further comprising means for adjusting the alignment of the first and second enclosing elements.

25. The apparatus of claim 19 further comprising means for measuring the alignment of the first and second enclosing elements.
